(19) United States
(12) Patent Application Publication
(10) Pub. No.: US 2010/0141636 A1
(43) Pub. Date: Jun. 10, 2010

(54) EMBEDDING AND TRANSMITTING DATA SIGNALS FOR GENERATING A DISPLAY PANEL

(75) Inventors: Sebastien Marsanne, Singapore (SG); Fabrice Boissieres, St Etienne de Tulmont (FR); Olivier Le-Briz, Saint-Gervais (FR); Lionel Vogt, La Rochette (FR)

Correspondence Address: STMICROELECTRONICS, INC., MAIL STATION 2346, 1310 ELECTRONICS DRIVE, CARROLLTON, TX, 75006, US

(73) Assignee: STMicroelectronics Asia Pacific Pte Ltd., Singapore (SG)

(21) Appl. No.: 12/330,842

(22) Filed: Dec. 9, 2008

(51) Int. Cl. G06F 3/038

(52) U.S. Cl. 345/213

(57) ABSTRACT

Row propagation delay is the duration it takes for a signal to travel the length of a row in a flat panel display matrix. Row propagation delay compensation modifies when column voltages are applied to each column in a flat panel matrix by substantially matching the delay for its position relative to the length of the row. A ternary signal generated by the timing controller with embedded clock and data information is buffered at the timing controller and transmitted to each column driver as required to substantially match row propagation delay while minimizing system interconnects and column driver circuitry.

### BACKGROUND OF THE INVENTION

1. Field of the Invention

Embodiments of the present invention relate, in general, to row and column drivers of flat panel displays and particularly to delaying column driver signals to match row driver signals.

2. Relevant Background

As display technology continues to advance, traditional cathode ray tube monitors are replaced by flat panel displays. Among flat panel displays, the thin-film transistor liquid crystal display (“TFT-LCD”) is the most popular. Such a display system panel comprises a pixel array described as a row-column matrix or lattice. Each junction of the lattice includes a switching device, typically a thin film transistor (TFT); a storage device, such as a capacitor; and an associated display element or pixel. To activate the switching devices to store the voltages necessary for appropriate pixels to display an image, column and row (also referred to herein as gate) drivers are used in conjunction with one or more display controllers. The display controllers generate timing signals, such as column and row driver enable signals, for the respective column and row drivers which, in turn, generate appropriate voltage signals for specific pixel addresses. The use of pixels arranged in a lattice, as opposed to a cathode ray tube, enables relatively large display areas with relatively small display panel thickness.

Each pixel in the lattice is addressed by a gate driver signal line and a column driver signal line; a desired driving voltage is applied to each pixel, via the column driver signal line, when its row is selected via the gate driver signal line. The aforementioned gate driver signal line and column driver signal line are each coupled to control circuitry that determines what voltage will be applied to each pixel in a common row when that row is selected. In a color display panel, each position in the lattice preferably includes three subpixels for respectively emitting the primary colors red, green, and blue to provide a full color display panel. During pixel addressing periods, individual row signal lines are selectively enabled to select one row of pixels at a time, and column signal lines of the LCD panel are selectively driven with voltages unique to the current image content of the LCD panel. Selective address voltages are generated by driver controllers that are specifically designed for direct coupling to the LCD panel row and column signal lines.

To refresh a display panel, a row enable signal is transmitted to a first row of display pixels. This row enable signal activates the transistors associated with each of the pixels on that row and enables the transistors to transfer voltages on the column signal lines to the capacitors associated with the relevant pixels in that row. Substantially simultaneous with the gate driver signal activation, a select plurality of the column signal lines is activated and voltages are transferred to the appropriate capacitors. For color displays, each pixel is associated with three column signal lines (red, green, and blue). The column signal line through which the voltage is transferred and the magnitude of that voltage determines what color an associated pixel will be and with what intensity the color will display. After a predetermined time for transfer, the row enable signal is switched low, storing the transferred voltage value in the capacitor. After a delay, the process is then repeated for the next sequential row on the display panel until all rows have been refreshed.

Early display panels were manufactured to have a relatively small screen size with a pixel density of 640×480 pixels. Accordingly the delay problems resulting from a signal traveling from the circuitry at one end of the display to the circuitry at another end of the display were considered to be negligible. Over time, however, display panels have become larger and pixel density has increased. These changes in display panels have compounded the once minor delay problems to a point in which it is no longer considered negligible.

As an illustration of the significance of potential delay involved in a refresh cycle, a conventional Quad eXtended Graphics Array (“QXGA”) display having 2,048 vertical columns and 1,536 horizontal rows of pixels will be discussed. For each vertical column of pixels in a color display, there are actually three vertical columns of storage devices for storing values, one each for red, green, and blue. Therefore, in a color QXGA display, there are 6,146 columns and 1,536 rows of signal lines. Displays are conventionally completely refreshed at a rate of at least 60 times per second, or at 60 Hz, to avoid flicker.

For each additional row of pixels added to the display, the available time to refresh those pixels decreases. Furthermore, at points where display row and column signal lines cross, parasitic capacitance is observed between the conductive signal lines. This parasitic capacitance may further slow signal propagation. Conventionally, there is approximately a 1 to 2.5 microseconds delay in the row enable signal by the end of a signal line in a QXGA display. Said another way, if the gate driver signal applied at one end of the row enables line switches from low to high at time zero, then the low to high transition will not appear at the opposite end of the row enable line for anywhere from 1 to 2.5 microseconds later. Practical factors currently limiting the state of the art dictate that such propagation delay be approximately 1 to 2.5 microseconds. Despite there only being approximately one-quarter the number of pixels in an Extended Graphics Array (“XGA”) display as in a QXGA display, the row enable signal propagation delay of an XGA display is approximately the same as that observed in a QXGA display. Display signal propagation delay may cause noticeable uneven display intensity or even display errors.

As the physical dimensions of the signal lines are increased, the physical space available for pixels necessarily decreases; this results in decreased pixel size, or aperture, and hence, less display surface area for active light modulation. In turn, less active light modulation area results in more light source power for the same display brightness effect. Increasing the thickness of the address conductors reduces the resistance at the expense of fabrication time. Reducing the overlap capacitance between the row and column line conductors through thicker dielectric separation also results in added fabrication expense. Attempts at resolving the effects of display signal propagation delay include providing duplicate column drivers, one at the top of the display and one at the bottom of the display, and duplicate row drivers, one at the left of the display and one at the right of the display. Displays using these approaches, however, require additional circuitry and still may experience the varied pixel intensity problems caused by signal propagation delay.

As XGA displays are expanded to Super eXtended Graphics Array (“SXGA”) displays having a resolution of 1280×1024 pixels electromagnetic interference (“EMI”) from the density of the interconnects becomes a limiting factor to the Complementary metal-oxide-semiconductor (“CMOS”) bus interface. Additionally, the maximum clock frequency in SXGA displays is limited to 50-660 MHz. As a result Reduced Swing Differential Signaling (“RSDS”) ® was developed, which provided support for SXGA displays using differential pairs for EMI reduction and resulted in clock frequency being increased to 90 MHz.

But as panels continued to grow in size (in excess of 37 inches measured diagonally) and consumers demanded full High Definition (“HD”) resolution (1920×1080 pixels), a concept known as mini-low-voltage differential signaling (“mini-LVDS”) arose. Mini-LVDS is a serial, intra-panel solution that serves as an interface between the timing control function and an LCD source driver. As an extension of the widely used, open specification LVDS LCD panel technology, mini-LVDS enabled designers to extend performance while reducing the size and cost associated with LCD-based systems. By using mini-LVDS bus width was reduced thus allowing for support of larger panels and clock frequency was increased to 180 MHz.

The success of mini-LVDS, however, was short lived as the requirement for 10 bit color LCD Television applications was developed calling for a 2× data rate of 120 Hz. The buffer cost, connector interfaces, and column driver price made mini-LVDS impractical.

The solution to this dilemma was found in Point-to-Point Differential Signaling (“PPDS”) ®. PPDS is a form of Horizontal Line Delay Compensation (“HLDC”). Rather than transition all of the outputs of all of column drivers simultaneously, HLDC compensates for propagation delay of the row signal by delaying output of each column driver by an amount that matches the propagation edge of the row signal as it passes that output. In HLDC each column driver time staggers its output transitions in step with the row-signal propagation to assure that the column driver changes start immediately after the row-signal falls. This means that since no output must wait for the gate signal to propagate, whether the column-driver output is near or far from the row driver, there is additional time to charge each pixel.

PPDS architecture combines a physical layer interface with high-level tailored bus protocol for compact Centre for Development of Advanced Computing (“C-DAC”) architecture to create an efficient interface that reduces the overall required printed circuit board size, albeit not a single layer printed circuit board. PPDS architecture is designed to drive large panels up to 90 inches at resolutions up to 1920×1080 lines at 275 MHz and provide individual column driver data bus control.

However the scan time for each line using PPDS remains fixed and the point to point benefit is limited to data thus there remains global control to all column drivers within a row. Since the total line time remains fixed (line time=on time+line delay), the line delay offered by PPDS as clock frequencies increase becomes very small. Thus as a matter of practicality, current versions of HLDC cannot be implemented in a working application.

### SUMMARY OF THE INVENTION

PPDS implemented using pulse-modulation signals in which a clock is embedded with a data bit in the same differential pair is hereafter disclosed by way of example. According to one embodiment of the present invention, propagation delay associated with each of a plurality of rows of pixels in a flat panel display is compensated for by transmitting a pulse-modulated signal from a timing control device to each of a plurality of column drivers in a sequential manner and so as to substantially match the propagation delay. The timing controller generates a pulse-modulated signal for each column driver associated with a flat panel display. The generated signals are individually and independently buffered at the timing controller such that the transmission of the pulse-modulated signal to its respective column driver matches and thus compensates for the row propagation delay. According to one embodiment of the present invention, the communication between the timing controller and each column driver is independent of each other column driver, and according to another embodiment the link between the timing controller and each column driver is point-to-point.

According to one embodiment of the present invention, the pulse-modulated signal is a three level differential pair that includes clock, data, and control information. In another embodiment of the present invention, the pulse-modulated signal includes column driver settings. Once the signal is received at the column driver, it is decoded and immediately executed to drive a voltage to a pixel that is rendered on by a corresponding row or gate driver. By delaying the transmission of the driving signal at the timing controller, circuitry at each column driver is reduced and clock and data information remain synchronized.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high level depiction of a flat panel display according to one embodiment of the present invention;

FIG. 2 shows a system interconnection diagram of a timing controller and a plurality of column drivers associated with a flat panel display according to one embodiment of the present invention;

FIG. 3 is a comparison of a timing diagram of a two line data bit signal and a ternary signal as implemented according to one embodiment of the present invention; and

FIG. 4 is a flowchart of one method embodiment for propagation delay compensation in column driver voltages according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF EMBODIMENTS

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

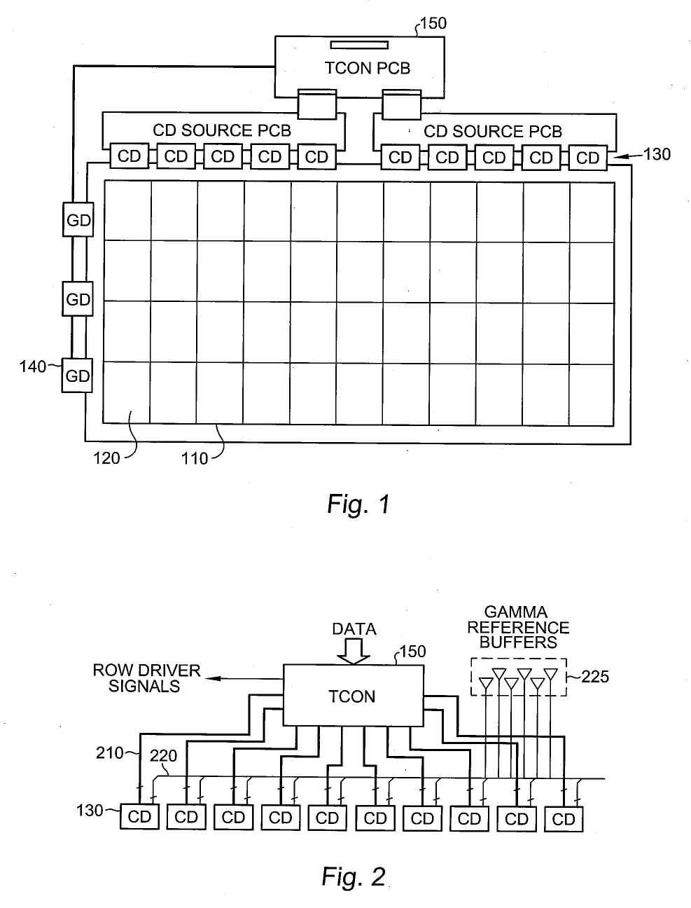

FIG. 1 is a high level depiction of a flat panel display according to one embodiment of the present invention. A display area 110 comprises a plurality of pixels 120 located at the intersections of rows and columns that form a flat panel lattice. Each intersection generally possesses a switch and a capacitor of some fashion that stores a voltage necessary for the pixel to display a certain image. Each row in the lattice is associated with its own row or gate driver 140 and each column is associated with its own column driver 130. The gate drivers 140 and the column drivers 130 are coupled to a timing controller 150 that directs when each pixel is to change or refresh based on incoming data.

When it is time to refresh a row of pixels, a row enable signal is produced from that row's driver in the sequence of row drivers. When a row enable signal goes high, the thin film transistors coupled to that row are turned on and the storage capacitors associated with the transistors begin to charge to the voltage present on their associated columns. Conventionally, the signals on each of the column signal lines are activated at substantially the same time. For column signal lines nearer the row driver (i.e. columns near the left side of the panel), the row enable signal has little or no propagation delay and, therefore, is high at the near column for all or nearly all of the time the column signal is activated. However, due to row enable signal propagation delay, the row enable signal may not reach columns farther from the row drivers until after the corresponding column signal has been activated. Recall that the charge available through the column signal falls within the time when the row enable signal is high at thr far column signal line and is, therefore, stored on an appropriate capacitor. The remaining portion of the charge, which ideally would have been available to help charge the appropriate capacitor, is missed due to the signal propagation delay. Furthermore, when the column signal transitions low before the row enable signal transitions low, the capacitor associated with the corresponding row and column address discharges until the row enable signal transitions low, thus, further decreasing the charge on the capacitor from its appropriate charge value.

Because capacitors charge asymptotically they never truly charge to their full desired and intended value, but the longer they charge the closer to their full value they reach. Capacitors with full values stored are closer to their intended intensity than those with less than their full voltage value stored. The net effect of uncompensated propagation delay is that the pixels farther from the row drivers may be proportionately less or more intense than those pixels nearer the row drivers, or that the colors emitted by pixels nearer the row drivers do not match the colors emitted by pixels farther from the row drivers.

According to one embodiment of the present invention, the column signal directing the column driver to place a voltage on a particular column is delayed to arrive at the column driver at substantially the same time that the row control signal arrives at the transistor turning it on and making it capable of accepting and storing the charge presented from the column driver. Each signal originating at the timing controller and arriving at a column driver is independent meaning that each column driver operates independent of each other column driver. According to one embodiment of the present invention, the communication link between the timing controller and each column driver is point-to-point. While existing point-to-point schemes require signals originating from the timing controller to be synchronized forcing each column driver to operate in unison, embodiments of the present invention remove that requirement allowing each column driver to operate independently so as to match the row propagation delay associated with each column.

FIG. 2 shows a high level interconnection diagram of column drivers associated with a flat panel display according to one embodiment of the present invention. Each column driver 130 is coupled to the timing controller 150 via a 2 bit interconnect 210. Additionally each column driver 130 is also coupled to a plurality of gamma reference buffers 225 via a 16 bit 220 interconnect. This simplified interconnection system is scalable to support resolutions including 1920×1080 scan lines resulting in 2,073,600 pixels.

According to one embodiment of the present invention pulse-amplitude modulation signals are used to transmit data and clock information to each column driver. A pulse-amplitude modulation (“PAM”) signal is a form of signal modulation where the message information is encoded in the amplitude of a series of signal pulses. Thus a PAM-3 signal includes the possible levels such as −1 volts, 0 volts, and +1 volts. Similarly differential signaling occurs when information is transmitted electrically by means of two or more complementary wires. One advantage to differential signaling is its resistance to electromagnetic interference. By balancing the lines a receiver can reduce the noise by rejecting common-mode interference. Since the lines have the same impedance to ground, the interfering fields or currents induce the same voltage in both wires. Noise can further be reduced by twisting the wire pairs as in Cat-3 Ethernet cable or telephone lines.

According to one embodiment of the present invention, the timing controller generates and transmits to each column driver a PAM-3 differential signal. Embedded in the signal is a clock reference that is easy for the receiving column driver circuitry to regenerate. Since the data and the clock are transmitted as a pair, there is no clock versus data skewing to consider, which is a typical problem when clock signals are separated from the data signal as in RSDS and mini-LVDS systems. Embedding the clock in a PAM-3 differential signal also avoids using 8b/10b ANSI coding, which requires a phase-lock loop or a delay-locked loop in the receiver. The result is the same performance at lower power levels and complexity. In addition a single pair differential signal reduces the interconnect system cost substantially. The cables, interconnects, and printed circuit boards can all be simplified and reduced resulting in substantial cost savings. Note that PAM-5 differential signals can be used so as to double bandwidth and are consistent with the present invention.

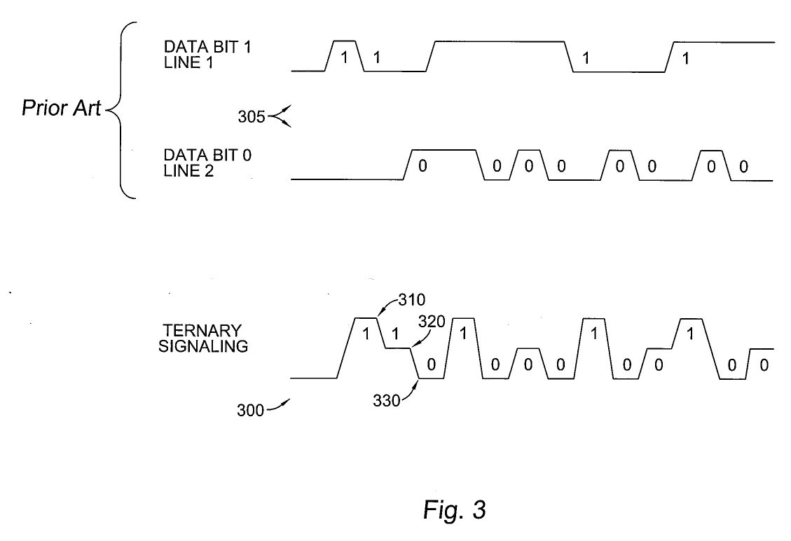

According to another embodiment of the present invention and as shown in FIG. 3, the timing controller can generate a ternary signal. A ternary signal is a signal that can assume, at any given instant, one of three significant conditions. For example the same signal can represent differing power levels, phase positions, pulse durations or frequencies. And while the PAM-3 differential signal is a form of ternary signal, so too are sine wave signals having different phases associated with a clock pulse or a carrier wave having one of three frequencies. Each of these types of signals are within the scope of the present invention.

FIG. 3 shows a comparison of two conventional data lines and a ternary signal scheme according to one embodiment of the present invention. The two upper signals 305 show a classic high-low state of a data line for a bit=1 and a bit=0 scenario. The same information can be placed on a single ternary signal 300. For example, a single ternary signal may comprise a bit 1 having high value, a bit 1 low signal (note: found in two separate data lines); that bit 1 low is equivalent to a high bit 0 value, a low bit 0 singal. Combining this type of ternary signaling reduces the complexity and cost of the interconnect and reduces time/data skewing.

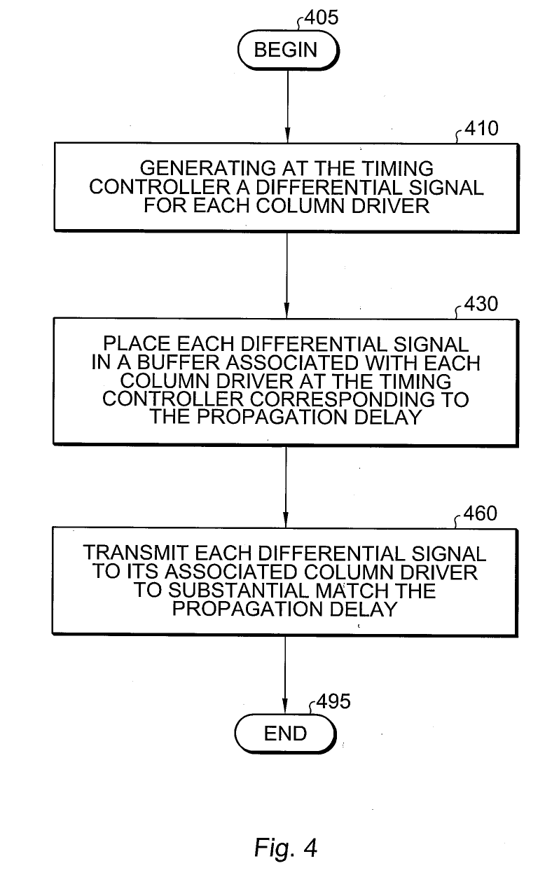

FIG. 4 is a flowchart illustrating methods of implementing an exemplary process for propagation delay compensation using a pulse-amplitude modulated differential signal. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

According to one method embodiment, the process begins 405 with the generation 410 of a differential signal pair at the timing controller for each column driver. As previously discussed this signal, according to another embodiment, can be a ternary signal such as a PAM-3 differential signal. Once the signal has been generated it is buffered 430 in a plurality of buffers located at the timing controller. According to one embodiment of the present invention, the timing controller includes a plurality of buffers wherein at least one buffer is associated with each of the plurality of column drivers so as to be calibrated to buffer the signal to substantially match the row propagation delay.

Thereafter the timing controller transmits 460 the signal to each column driver consistent with the delay caused by the interceding buffer. Upon receipt at the column driver the signal is decoded causing the column driver to issue a voltage to the capacitor associated with the pixel simultaneously with the row driver enabling the capacitor to accept the charge, ending 495 the process. Each signal transmission to each column driver is, according to one embodiment of the present invention, a point-to-point communication. In addition each column driver operates independent of each other column driver thus eliminating signal synchronization.

According to another embodiment of the present invention, each column driver includes a buffer capable of delaying issuance of the voltage to the column so as to be aligned with row propagation delay. While the transmission of the signal from the timing controller to the column driver remains a point-to-point link, the buffering to match the propagation delay occurs at the column driver itself rather than at the timing controller. The independent feature of each column driver remains.

While there have been described above the principles of the present invention in conjunction with compensating row propagation delay, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A method for signal propagation delay compensation associated with operating a flat panel display, the flat panel display including a plurality of pixels arranged in an array of a plurality of rows and a plurality of columns, a plurality of row drivers wherein each row driver is coupled to at least one row of pixels and wherein each row driver is operative to apply a row enable signal, a plurality of column drivers wherein each column driver is coupled to at least one column of pixels and wherein each column driver is operative to apply a driving voltage, the plurality of columns including a first column proximate to the row drivers and a second column relatively distant from the row drivers, each row enabled signal being subject to a propagation delay along a selected row as measured for the first column to the second column and, the method comprising:
at a timing controller, generating a differential signal to each column driver wherein the timing controller delays transmitting the differential signal directed to the column driver associated with the second column with respect to the differential signal directed to the first column by a period of time substantially equal to the propagation delay.

2. The method of claim 1 further comprising independently buffering each differential signal at the timing controller.

3. The method of claim 1 wherein the differential signal is a pulse-amplitude modulation signal.

4. The method of claim 3 wherein the pulse-amplitude modulation signal is a three level differential pair.

5. The method of claim 4 wherein the pulse-amplitude modulation signal includes a clock signal and a data signal.

6. The method of claim 3 wherein the pulse-amplitude modulation signal is a ternary signal.

7. The method of claim 1 wherein communication between the timing controller and each column driver is point-to-point.

8. The method of claim 7 wherein each column driver operates independent of each other column driver.

9. A system for signal propagation delay compensation associated with operating a flat panel display, the system comprising:
a plurality of pixels arranged in an array of a plurality of rows and a plurality of columns;
a plurality of row drivers wherein each row driver is coupled to at least one row of pixels and wherein each row driver is operative to apply a row enable signal;
a plurality of column drivers wherein each column driver is coupled to at least one column of pixels and wherein each column driver is operative to apply a driving voltage, wherein the plurality of columns including a first column proximate to the row drivers and a second column relatively distant from the row drivers, each row enabled signal being subject to a propagation delay along a selected row as measured for the first column to the second column; and
a timing controller operative to generate a differential signal associated with each column driver, wherein the timing controller delays transmitting the differential signal directed to the column driver associated with the second column with respect to the differential signal directed to the first column by a period of time substantially equal to the propagation delay.

10. The system of claim 9 wherein the timing controller includes a plurality of buffers operative to independently buffer each differential signal.

11. The system of claim 9 wherein the differential signal is a pulse-amplitude modulation signal.

12. The system of claim 11 wherein the pulse-amplitude modulation signal is a three level differential pair.

13. The system of claim 12 wherein the pulse-amplitude modulation signal includes a clock signal and a data signal.

14. The system of claim 11 wherein the pulse-amplitude modulation signal is a ternary signal.

15. The system of claim 9 wherein communication between the timing controller and each column driver is point-to-point.

16. The system of claim 15 wherein each column driver operates independent of each other column driver.

17. A timing controller for compensation signal propagation delay in a flat panel display, the flat panel display including a plurality of pixels arranged in an array of a plurality of rows and a plurality of columns, a plurality of row drivers wherein each row driver is coupled to at least one row of pixels and wherein each row driver is operative to apply a row enable signal, a plurality of column drivers wherein each column driver is coupled to at least one column of pixels and wherein each column driver is operative to apply a driving voltage, the plurality of columns including a first column proximate to the row drivers and a second column relatively distant from the row drivers, each row enabled signal being subject to a propagation delay along a selected row as measured for the first column to the second column and, the timing controller comprising:
circuitry operative to generate a differential signal to each column driver and operative to delay transmission of each differential signal such that the differential signal directed to the column driver associated with the second column with respect to the differential signal directed to the first column is delayed by a period of time substantially equal to the propagation delay.

18. The timing controller of claim 17 further comprising a plurality of buffers operative to independently buffer each differential signal.

19. The timing controller of claim 18 wherein the differential signal is a pulse-amplitude modulation signal.

20. The timing controller of claim 19 wherein the pulse-amplitude modulation signal is a three level differential pair.

21. The timing controller of claim 20 wherein the pulse-amplitude modulation signal includes a clock signal and a data signal.

22. The timing controller of claim 21 wherein the pulse-amplitude modulation signal includes column driver control signals.

23. The timing controller of claim 22 wherein the pulse-amplitude modulation signal includes column driver setting signals.

24. The timing controller of claim 19 wherein the pulse-amplitude modulation signal is a ternary signal.

25. The timing controller of claim 17 wherein communication between the timing controller and each column driver is point-to-point.

26. The timing controller of claim 25 wherein each column driver operates independent of each other column driver.
